(19) United States
(12) Patent Application Publication
(10) Pub. No.: US 2019/0094092 A1
(43) Pub. Date: Mar. 28, 2019

(54) DIAPHRAGM PRESSURE GAUGE

(71) Applicant: MOPAN CO., LTD., Chiayi City (TW)

(72) Inventor: Chia-Hsin LEE, Chiayi City (TW)

(73) Assignee: MOPAN CO., LTD., Chiayi City (TW)

(21) Appl. No.: 15/715,845

(22) Filed: Sep. 26, 2017

(51) Int. Cl. G01L 7/08

(52) U.S. Cl. CPC G01L 7/082; G01L 13/025; G01L 7/084

(57) ABSTRACT

A diaphragm pressure gauge for measuring a pressure of a fluid includes a cylinder, a pressure measuring unit and a pressure detecting assembly. The pressure measuring unit has first and second diaphragms disposed to define first, second and third subchamber in the cylinder. The first diaphragm includes a main diaphragm layer and a reinforcing layer attached to the main diaphragm layer and in the second subchamber such that the first diaphragm is deformable to permit axial movement when subject to an internal pressure of the fluid introduced in the first subchamber. A connecting rod is disposed in the second subchamber to be actuated by the axial movement of the first diaphragm to move the second diaphragm. The pressure detecting assembly is disposed in the third subchamber to detect the movement of the second diaphragm so as to indicate the pressure of the fluid.

### FIELD

The disclosure relates to a pressure gauge, and more particularly to a diaphragm pressure gauge for measuring a pressure of a fluid.

### BACKGROUND

Referring to FIG. 1, a conventional diaphragm pressure gauge 1 for measuring a pressure of a fluid 10 includes a cylinder 11, a pressure measuring unit 12 and a pressure detecting assembly 13. The cylinder 11 has a base 111 and a cover 112 connected to each other to define a cylindrical chamber 113 therein. The pressure measuring unit 12 has an elastic metal diaphragm 121 disposed in the cylindrical chamber 113 and gripped by the base 111 and the cover 112 at a periphery to divide the cylindrical chamber 113 into first and second subchambers 114, 115, and a rupture disc 122 disposed to protect the metal diaphragm 121 from excessive deformation. The pressure detecting assembly 13 has a pressing sleeve 131 connected with the diaphragm 121 through a screw 132 to be moved lengthwise with the deformation of the diaphragm 121 when the diaphragm 121 is subject to an internal pressure of the fluid 10 introduced in the first subchamber 114. The movement of the pressing sleeve 131 results in rotation of a spindle 134 to drive a pointer 133 to rotate in order to indicate the detected pressure of the fluid 10.

However, the diaphragm 121 made of an elastic metal material may get rusted and corroded due to direct contact with the detected fluid 10 that may be corrosive chemicals or a thickened and granular fluid. The diaphragm 121 and the screw 132 which directly contact the detected fluid 10 are liable to adhesion, corrosion and pollution by the fluid 10 and hence to shortening of the service life, which adversely affects the accuracy of the diaphragm pressure gauge 1.

Referring to FIG. 2, another conventional diaphragm pressure gauge 9 includes a second diaphragm 922 disposed in a cylinder 91 and connected with a rubber-made first diaphragm 921 through a connecting shaft 923 to transmit the displacement of the first diaphragm 921 to the second diaphragm 922. The second diaphragm 922 is protected from contacting a detected fluid. However, the fluid adheres to and is attached to the first diaphragm 921, hence interfering the displacement thereof. The fluid might corrode the first diaphragm 921 made from a single rubber layer, thus rendering the measuring operation malfunctioned.

### SUMMARY

Therefore, an object of the disclosure is to provide a diaphragm pressure gauge that can alleviate at least one of the drawbacks of the prior art.

According to the disclosure, the diaphragm pressure gauge includes a cylinder, a pressure measuring unit and a pressure detecting assembly. The cylinder has a base and a cover connected to each other at peripheral walls thereof to define a cylindrical chamber. The pressure measuring unit is disposed in the cylinder, and has a first diaphragm, a second diaphragm spaced apart from the first diaphragm in a lengthwise direction, and a connecting rod operatively connected between the first and second diaphragms. The cylindrical chamber has a first subchamber which is defined by the base and the first diaphragm and which is configured for introduction of a fluid to be measured, a second subchamber which is defined by the first diaphragm and the second diaphragm, and a third subchamber which is defined by the second diaphragm and the cover. The first diaphragm includes a main diaphragm layer and a reinforcing layer. The main diaphragm layer has a first flange wall clamped between the peripheral walls of the base and the cover, and a first main diaphragm wall extending radially and inwardly from the first flange wall to divide the cylindrical chamber into the first and second subchambers. The reinforcing layer is attached to the first main diaphragm wall and is disposed in the second subchamber such that the first diaphragm is deformable to permit axial movement thereof in the lengthwise direction when subject to an internal pressure of the fluid introduced in the first subchamber. The connecting rod is disposed in the second subchamber and is actuated by the axial movement of the first diaphragm to move the second diaphragm. The pressure detecting assembly is disposed in the third subchamber to detect the movement of the second diaphragm so as to indicate the pressure of the fluid.

According to the disclosure, the diaphragm pressure gauge includes a cylinder, a pressure measuring unit and a pressure detecting assembly. The first diaphragm of the pressure measuring unit has a raised portion which projects in the lengthwise direction to be connected to the second diaphragm.

### BRIEF DESCRIPTION OF THE DRAWINGS

Other features and advantages of the disclosure will become apparent in the following detailed description of the embodiments with reference to the accompanying drawings, of which:

FIG. 1 is a sectional view of a conventional diaphragm pressure gauge;

FIG. 2 is a sectional view of another conventional diaphragm pressure gauge;

FIG. 3 is a sectional view illustrating a first embodiment of a diaphragm pressure gauge according to the disclosure;

FIG. 4 is a schematic top view illustrating a first diaphragm of the first embodiment;

FIGS. 5 to 7 are schematic top views illustrating a second diaphragm of second, third and fourth embodiments, respectively; and

FIGS. 8 to 15 are sectional view illustrating fifth to twelfth embodiments of a diaphragm pressure gauge according to the disclosure, respectively.

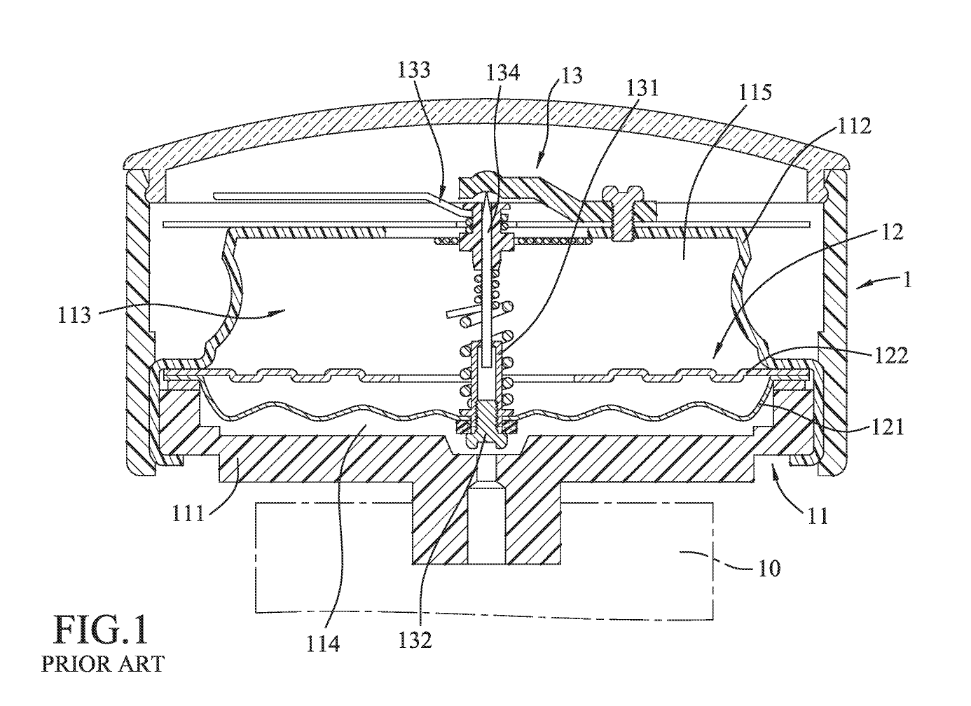

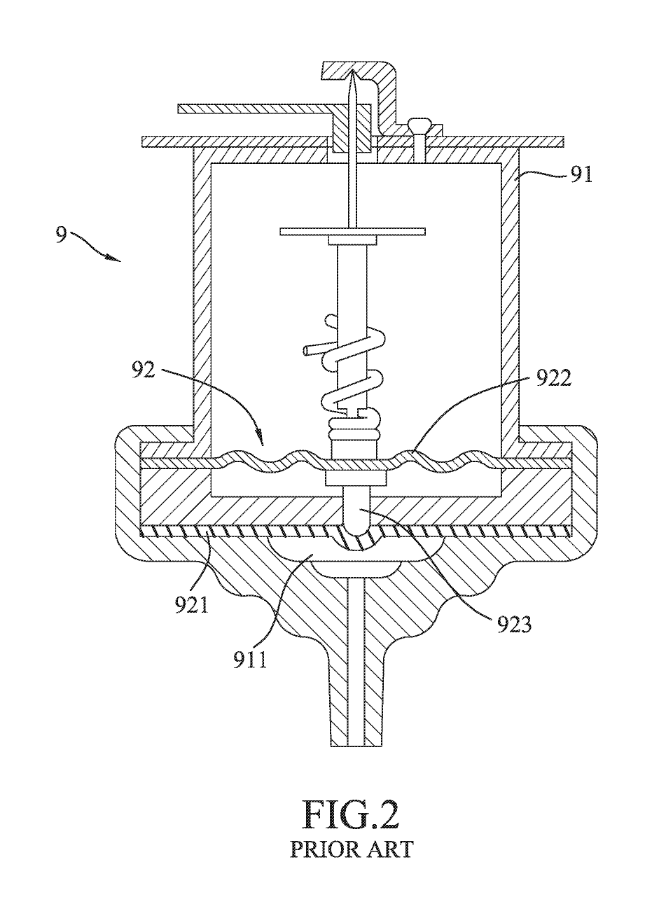

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

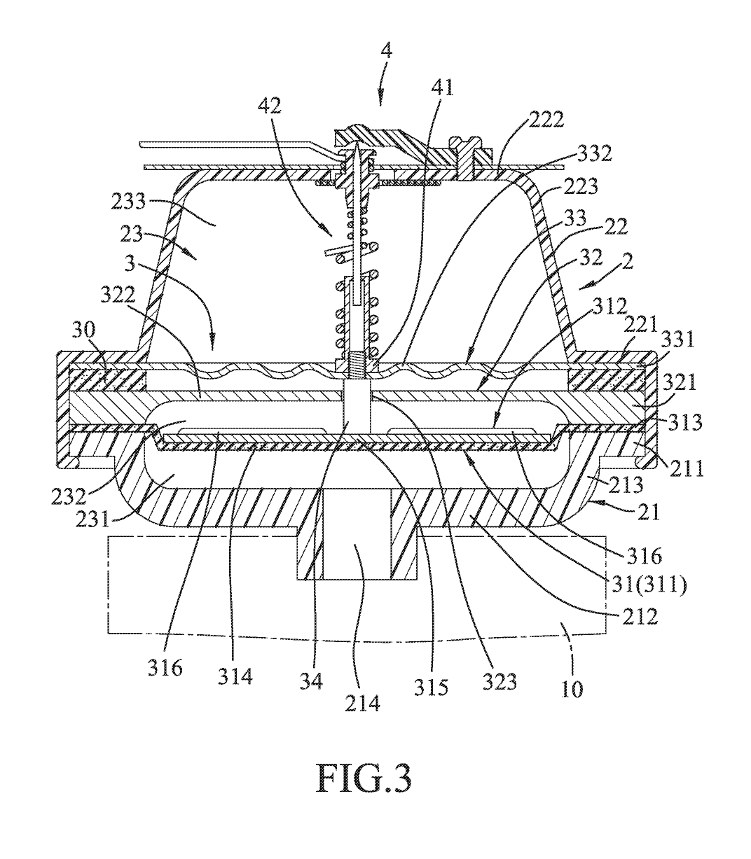

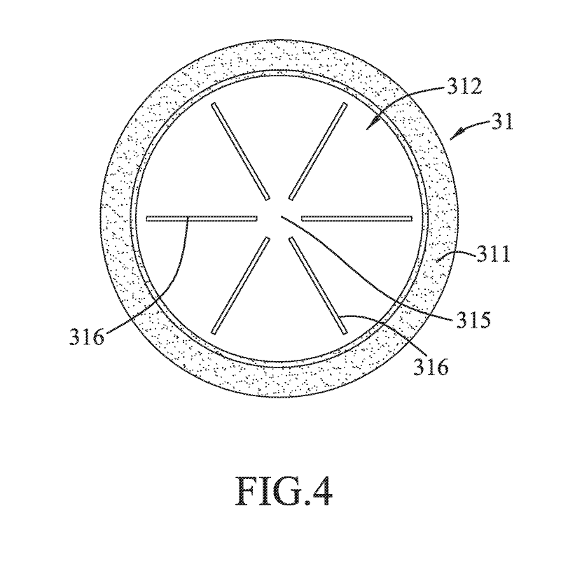

Referring to FIGS. 3 and 4, a first embodiment of a diaphragm pressure gauge according to the disclosure for measuring a pressure of a fluid 10 includes a cylinder 2, a pressure measuring unit 3 and a pressure detecting assembly 4.

The cylinder 2 has a base 21 and a cover 22 which are connected to each other at peripheral walls 211, 221 thereof to define a cylindrical chamber 23. The base 21 has a surrounding wall 213 extending downwardly from the peripheral wall 211, and a base wall 212 extending radially and inwardly from the surrounding wall 213 to terminate at a central portion. The central portion is formed with a first channel 214 in spatial communication with the cylindrical chamber 23 for entry of the fluid 10 to be detected. The cover 22 has a surrounding wall 223 extending upwardly from the peripheral wall 221, and a cover wall 222 extending radially and inwardly from the surrounding wall 223.

The pressure measuring unit 3 is disposed in the cylinder 2, and has a first diaphragm 31, a second diaphragm 33 which is spaced apart from the first diaphragm 31 in a lengthwise direction, a rupture disc 32 which is disposed between the first and second diaphragms 31, 33, a connecting rod 34 which extends through the rupture disc 32 and which is operatively connected between the first and second diaphragms 31, 33, and an engaging ring 30 clamped between the second diaphragm 33 and the rupture disc 32. The cylindrical chamber 23 has a first subchamber 231 which is defined by the base wall 212 and the first diaphragm 31 and which is in spatial communication with the first channel 214 for introduction of the fluid 10, a second subchamber 232 which is defined by the first diaphragm 31 and the second diaphragm 33, and a third subchamber 233 which is defined by the second diaphragm 33 and the cover wall 222.

The first diaphragm 31 includes a main diaphragm layer 311 facing the first subchamber 231, and a reinforcing layer 312 facing the second subchamber 232. The main diaphragm layer 311 is made from an elastomeric material, such as rubber, plastic (e.g. Teflon), stainless steel, silicone, etc., and has a first flange wall 313 mounted on the peripheral wall 211 of the base 21, and a first main diaphragm wall 314 extending radially and inwardly from the first flange wall 313 to divide the cylindrical chamber 23 into the first and second subchambers 231, 232. The reinforcing layer 312 is mounted on or attached to the first main diaphragm wall 314 and in the second subchamber 232, and has a central layer portion 315 and a plurality of reinforcing ribs 316 each extending radially and outwardly from the central layer portion 315. With the aforesaid dual-layered structure, the structural strength of the first diaphragm 31 is increased. The reinforcing layer 312 may be integrally formed with the main diaphragm layer 311 by an injecting forming, for example. The rupture disc 32 is made of a rigid material, and has a flange 321 which is disposed between the peripheral walls 211, 221, and a main rupture wall 322 which is spaced apart from the reinforcing layer 312 to protect the first diaphragm 31 from excessive deformation. The main rupture wall 322 has a through hole 323 at a central portion thereof.

The second diaphragm 33 is made from an elastomeric material, such as plastic, metal (e.g. copper), etc., and has a second flange wall 331 in a fluid-tight engagement with the peripheral wall 221 of the cover 22, and a second main diaphragm wall 332 extending radially and inwardly from the second flange wall 331 to divide the cylindrical chamber 23 into the second and third subchambers 232, 233. The second main diaphragm wall 332 is of a wave shape.

The connecting rod 34 extends through the through hole 323 to have first and second rod ends connected to the first and second diaphragms 31, 33, respectively. In this embodiment, the first rod end abuts against and may be fastened to the central layer portion 315 of the first diaphragm 31, and the second rod end extends through the second diaphragm 33 and is connected with the pressure detecting assembly 4 such that the second diaphragm 33 is tightly engaged with the connecting rod 34 and the pressure detecting assembly 4.

The pressure detecting assembly 4 is disposed in the third subchamber 233 to detect movement of the second diaphragm 33 so as to indicate the pressure of the detected fluid 10. The pressure detecting assembly 4 may be of a known electronic or mechanical type to translate the movement of the second diaphragm 33 to a pressure signal. In this illustrated embodiment, the pressure detecting assembly 4 has a pressing sleeve 41 coupled with the second diaphragm 33 through the connecting rod 34, and a moving member 42 translating the movement of the pressing sleeve 41 to generate a torque that drives a pointer part to operate for indicating a value of the pressure of the detected fluid 10.

In use, the detected fluid 10 is introduced into the first subchamber 231 from the first channel 214 to have the internal pressure acting on the first diaphragm 31 so as to cause deformation of the first diaphragm 31. With the connection of the connecting rod 34 with the first diaphragm 31 having the reinforcing layer 312 including the central layer portion 315 and the reinforcing ribs 316, the first diaphragm 31 is axially moved in the lengthwise direction to precisely drive the movement of the second diaphragm 33 and the pressing sleeve 41 so as to actuate the pressure detecting assembly 4 to indicate a detected pressure.

In this embodiment, the second diaphragm 33 transmitting the displacement thereof to the pressure detecting assembly 4 to generate a pressure indication does not contact the detected fluid 10 to avoid adhesion and pollution. The first diaphragm 31 with the dual-layered structure has great structural strength and stability and can be prevented from corrosion. Moreover, with the connecting rod 34 bracing and connected between the first and second diaphragms 31, 33, and with the pressing sleeve 41 aligned with the connecting rod 34 in the lengthwise direction, a pressing force generated as a result of the pressure of the fluid 10 can be magnified to ensure the preciseness of the measuring of the pressure gauge, and to enlarge the pressure detecting scope of the pressure gauge.

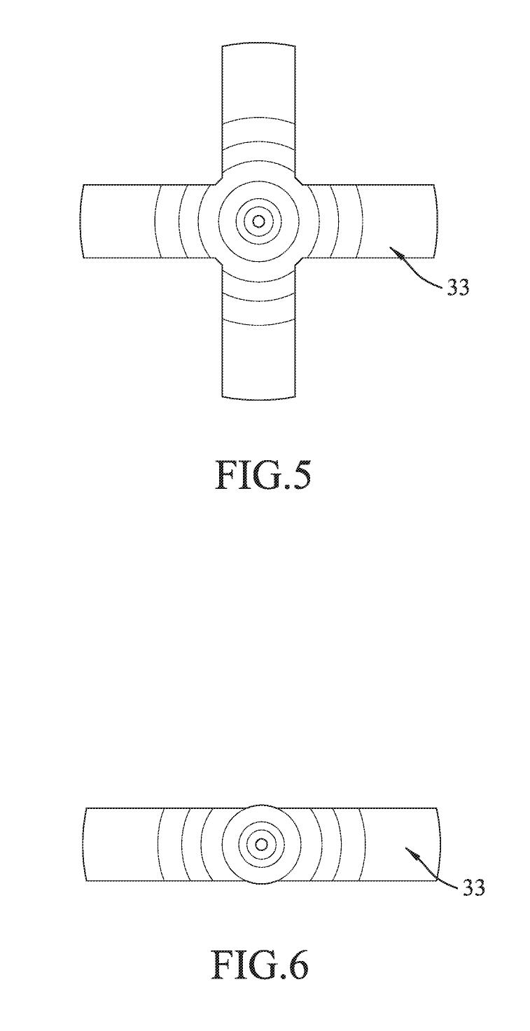

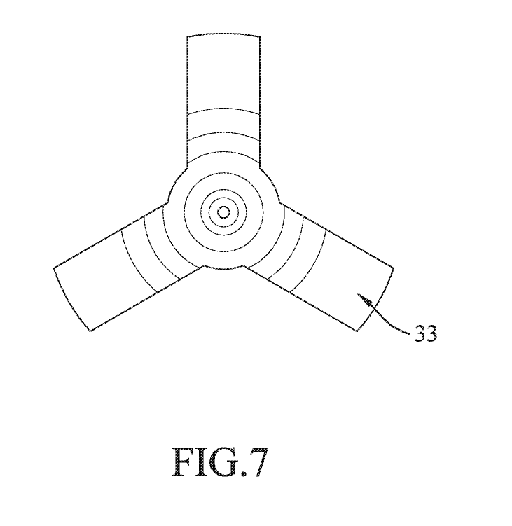

In this embodiment, the second diaphragm 33 is of a disc shape. Since the second diaphragm 33 according to the disclosure is not required to be in air-tight engagement with the cylinder 2, referring to FIGS. 5 to 7 respectively illustrating the second diaphragm. 33 of second, third and fourth embodiments, the second diaphragm 33 may be of a cross shape, a bar shape or a Y-shape.

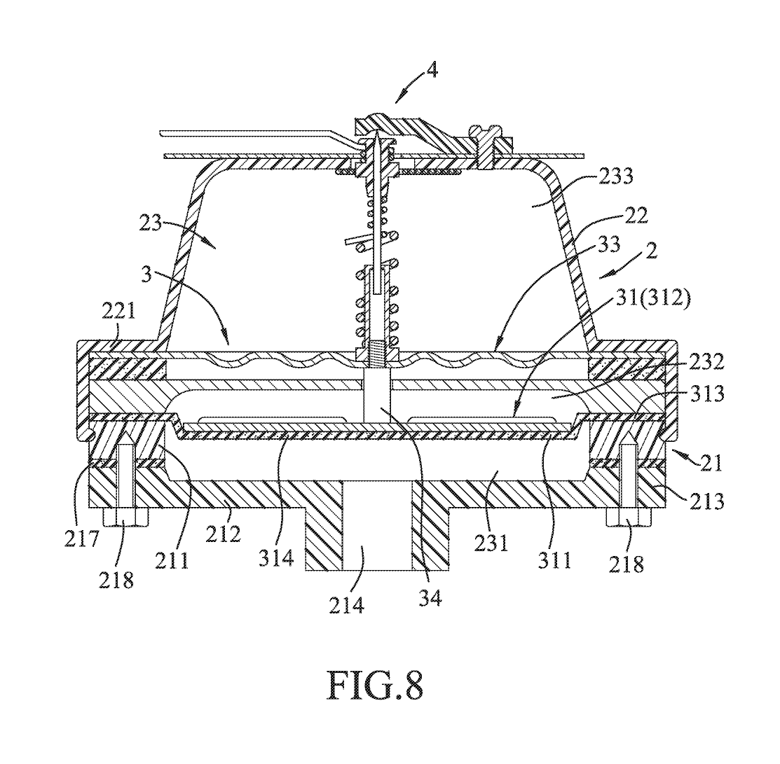

Referring to FIG. 8, in a fifth embodiment, the peripheral wall 211 of the base 21 is removably fastened to the surrounding wall 213 through a seal ring 217 and a plurality of screw fasteners 218 such that the base 21 is removable from the cover 22 for facilitating cleaning of the inside parts in the cylinder 2, and replacement of the base 21 to vary the dimension of the first channel 214 as required. Thus, the pressure detecting scope of the pressure gauge can be enlarged.

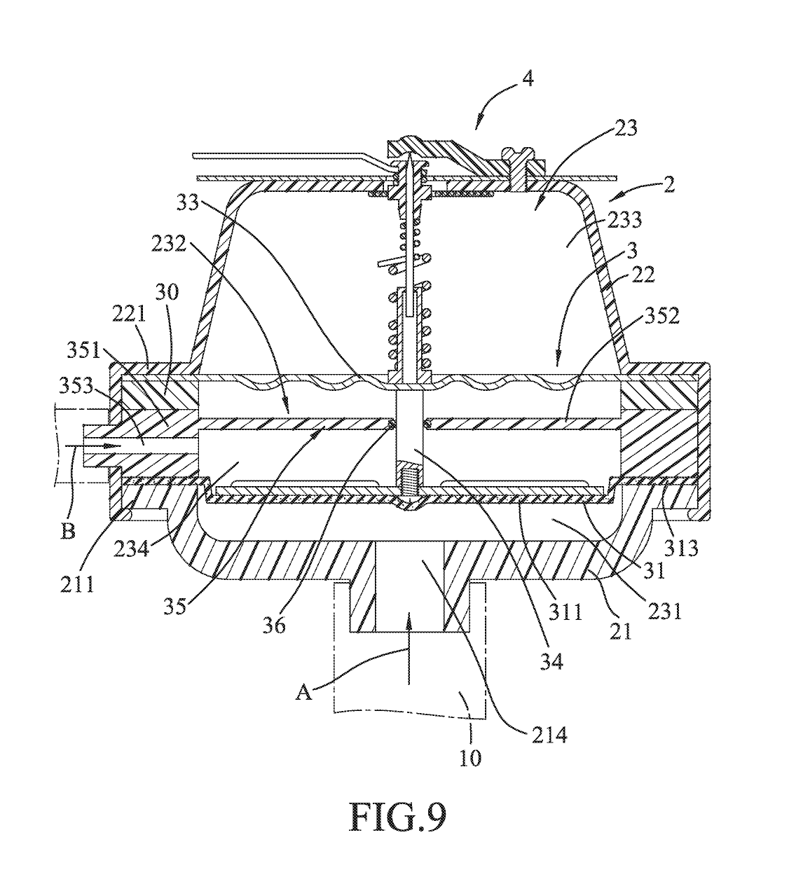

Referring to FIG. 9, the diaphragm pressure gauge in a sixth embodiment is used as a differential pressure gauge. Specifically, the pressure measuring unit 3 has an annular spacer disc 35 which is disposed in the cylindrical chamber 23 and between the first and second diaphragms 31, 33 and through which the connecting rod 34 extends, and a seal ring 36 which is disposed to seal between the connecting rod 34 and the spacer disc 35. The spacer disc 35 has a peripheral wall 351 clamped between the peripheral walls 211, 221, and a spacer wall 352 extending radially and inwardly from the peripheral wall 351 such that the second subchamber 232 has a differential pressure region 234 defined by the first diaphragm 31 and the spacer disc 35. The peripheral wall 351 of the spacer disc 35 has a second channel 353 extending transversely and in spatial communication with the differential pressure region 234 for introduction of another fluid (B). The spacer disc 35 may be configured to serve as a rupture disc.

In use, a fluid (A) of a detected object 10 enters the first subchamber 231 through the first channel 214, and another fluid (B) with a smaller internal pressure than that of the fluid (A) enters the differential pressure region 234 through the second channel 353. The difference in pressures of the fluids (A) and (B) results in the displacement of the connecting rod 34 and the second diaphragm 33 so as to measure the pressure drop. The fluids (A) and (B) flow into the first subchamber 231 and the differential pressure region 234, respectively, and do not contact the second diaphragm 33 so as to prevent the second diaphragm 33 from adhesion and pollution.

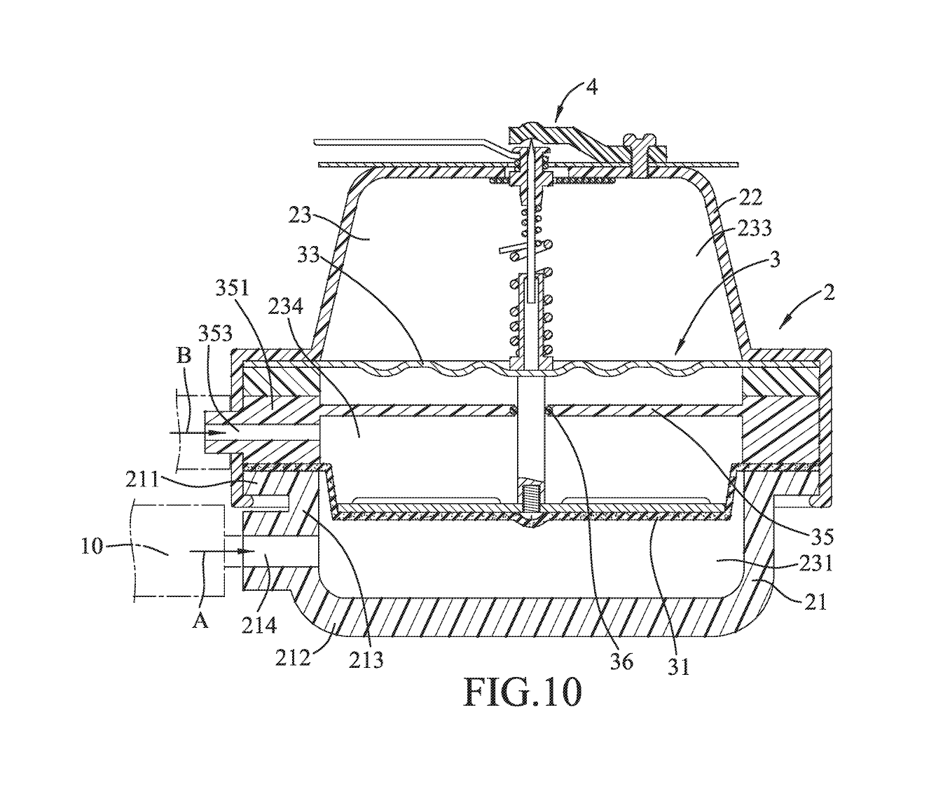

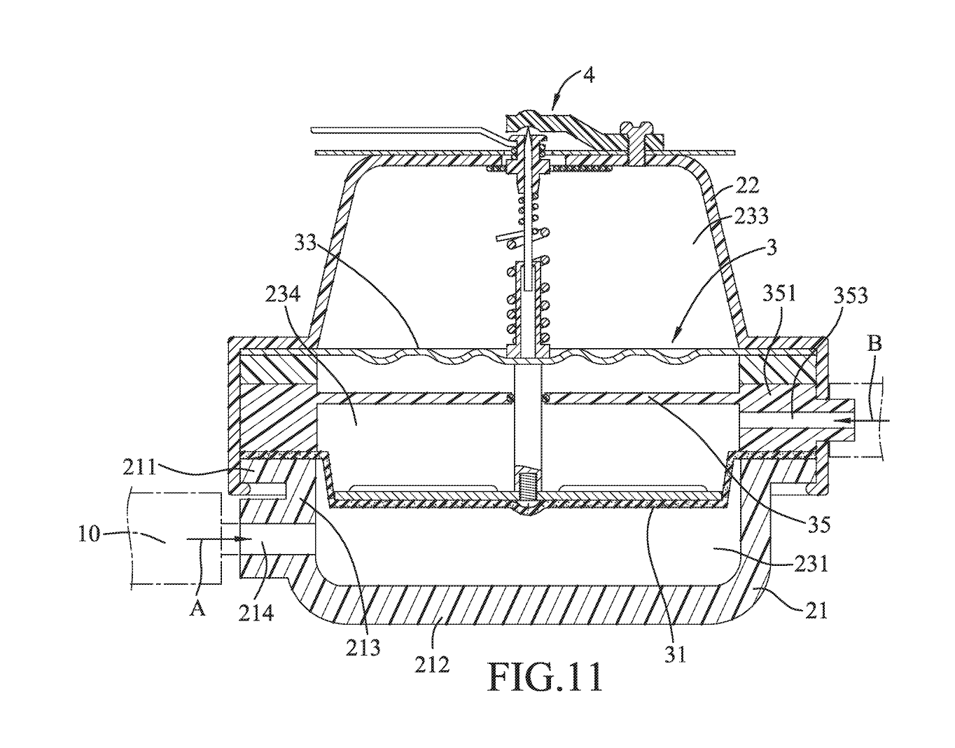

Referring to FIG. 10, in a seventh embodiment, the first channel 214 is formed in the surrounding wall 213 of the base 21 to vary the flow direction of the fluid (A) for facilitating coupling of the detected object 10 with the pressure gauge. Alternatively, referring to FIG. 11, in an eighth embodiment, the first channel 214 and the second channel 353 are formed at two opposite sides of the cylinder 2.

As illustrated above, with the structure that the pressure measuring unit 3 is clamped between the base 21 and the cover 22, the base 21 and the cover 22 can be made in a modular manner. The rupture disc 32 and the spacer disc 35 can be selectively assembled in the cylinder 2 to use the pressure gauge as a general pressure gauge or a differential pressure gauge.

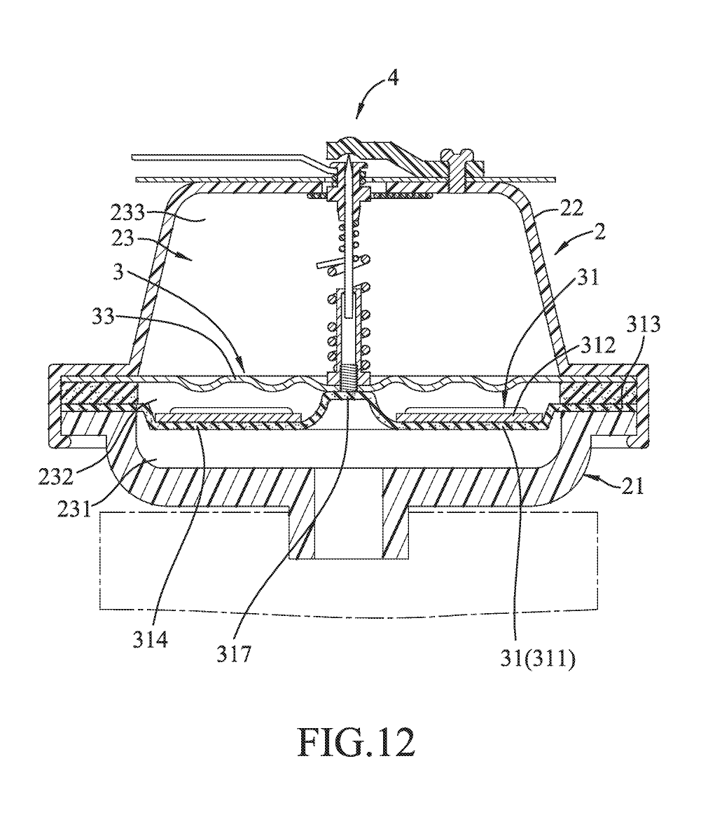

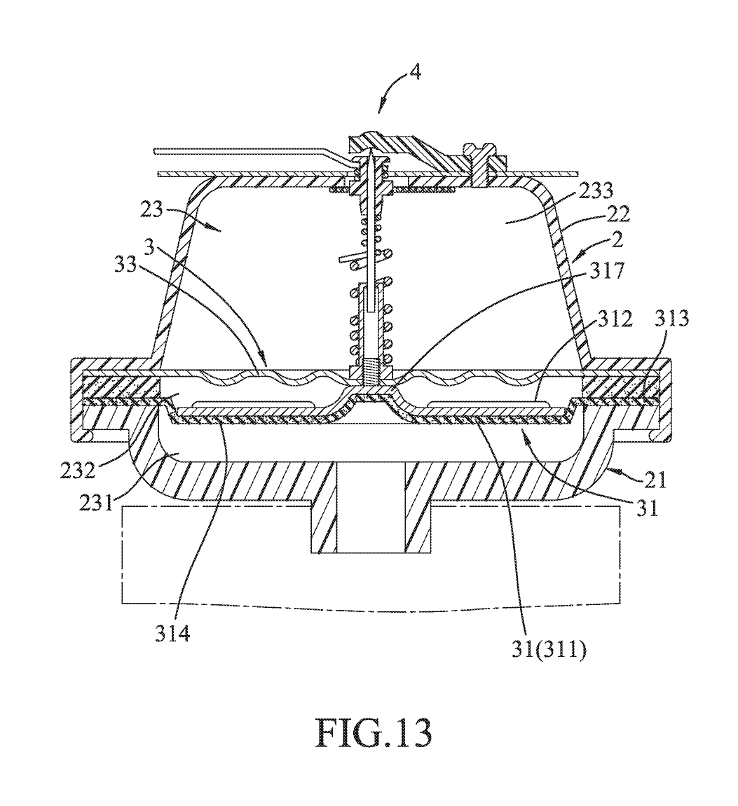

Referring to FIG. 12, in a ninth embodiment, the first diaphragm 31 has a raised portion 317 which projects in the lengthwise direction to be connected to the second diaphragm 33. In this embodiment, the main diaphragm layer 314 has a central portion which is raised over the reinforcing layer 312 to serve as the raised portion 317. Thus, a connecting rod as illustrated in the previous embodiments can be dispensed with. Alternatively, referring to FIG. 13 illustrating a tenth embodiment, the main diaphragm layer 314 and the reinforcing layer 312 respectively have central portions which are raised to serve as the raised portion 317.

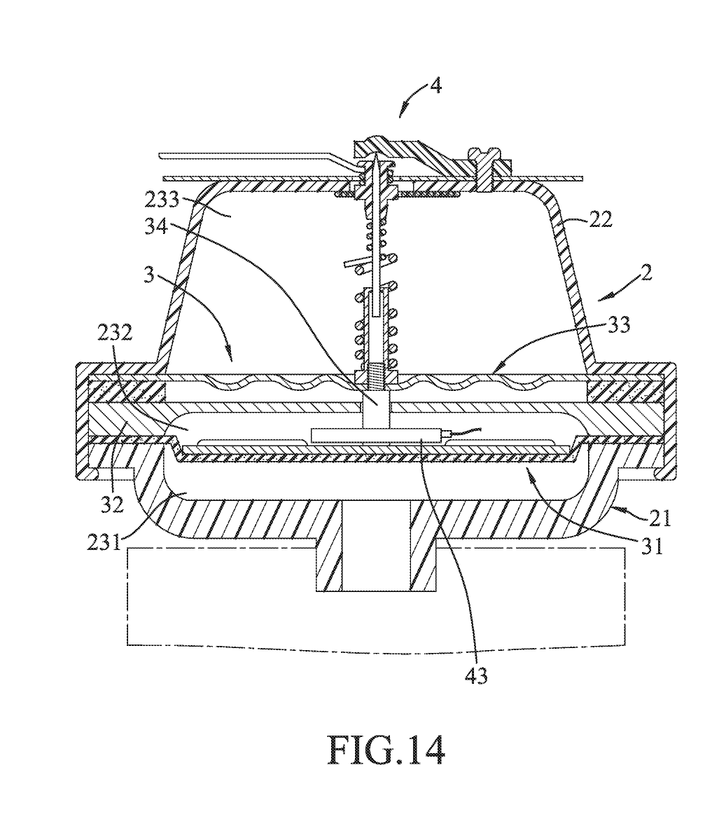

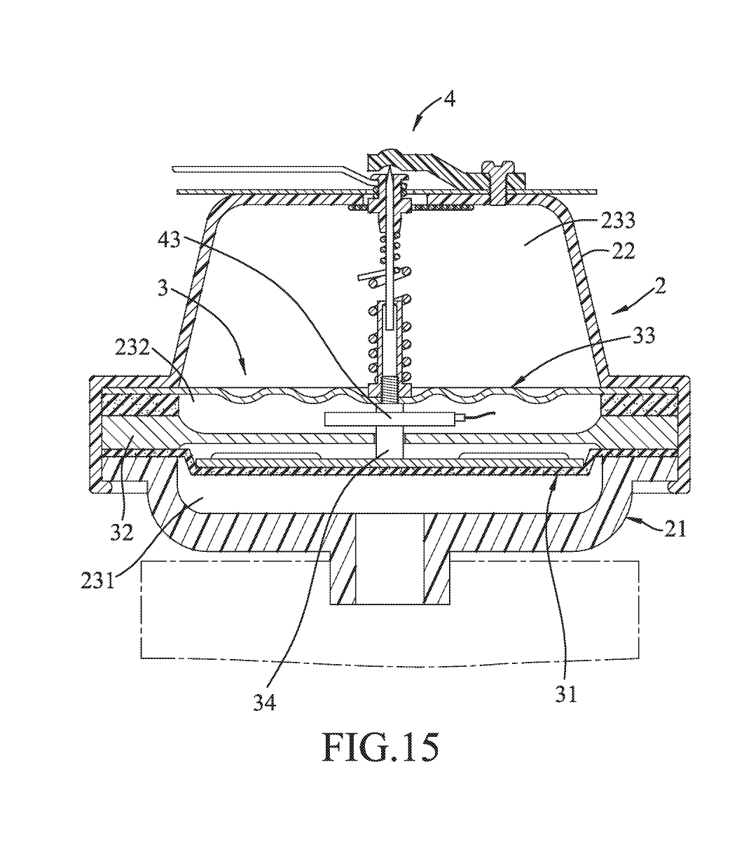

Referring to FIG. 14, in an eleventh embodiment, the pressure detecting assembly 4 has a load cell 43 which is disposed on the connecting rod 34 to create and output an electrical signal representing the measured pressure. In this embodiment, the load cell 43 is disposed below the rupture disc 32. Alternatively, in a twelfth embodiment shown in FIG. 15, the load cell 43 is disposed above the rupture disc 32.

In the previous embodiments, the pressure detecting assembly 4 is made with a mechanical design. As described above in the eleventh and twelfth embodiments, the pressure gauge may be connected with a digital pressure indicator to indicate mechanically and digitally the measured pressure, or for monitoring purposes. Moreover, the load cell 43 may be connected with a solenoid operated in response to the measured pressure to generate an alarm mark for monitoring a system employing the pressure gauge. The load cell 43 may be connected with a pressure relief valve to control or limit the pressure in a system in response to the measured pressure.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A diaphragm pressure gauge for measuring a pressure of a fluid, comprising:
a cylinder having a base and a cover which are connected to each other at peripheral walls thereof to define a cylindrical chamber;
a pressure measuring unit disposed in said cylinder, and having a first diaphragm, a second diaphragm which is spaced apart from said first diaphragm in a lengthwise direction, and a connecting rod which is operatively connected between said first and second diaphragms, said cylindrical chamber having a first subchamber which is defined by said base and said first diaphragm and which is configured for introduction of the fluid, a second subchamber which is defined by said first diaphragm and said second diaphragm, and a third subchamber which is defined by said second diaphragm and said cover, said first diaphragm including a main diaphragm layer which has a first flange wall that is clamped between said peripheral walls of said base and said cover, and a first main diaphragm wall that extends radially and inwardly from said first flange wall to divide said cylindrical chamber into said first and second subchambers, and a reinforcing layer that is attached to said first main diaphragm wall and in said second subchamber such that said first diaphragm is deformable to permit axial movement thereof in the lengthwise direction when subject to an internal pressure of the fluid introduced in said first subchamber, said connecting rod being disposed in said second subchamber and actuated by the axial movement of said first diaphragm to move said second diaphragm; and
a pressure detecting assembly disposed in said third subchamber to detect the movement of said second diaphragm so as to indicate the pressure of the fluid.

2. The diaphragm pressure gauge as claimed in claim 1, wherein said reinforcing layer has a central layer portion and a plurality of reinforcing ribs each extending radially and outwardly from said central layer portion, said connecting rod having a first rod end which abuts against said central layer portion.

3. The diaphragm pressure gauge as claimed in claim 1, wherein said second diaphragm has a second flange wall in a fluid-tight engagement with said cylinder, and a second main diaphragm wall extending radially and inwardly from said second flange wall to divide said cylindrical chamber into said second and third subchambers, said second main diaphragm wall being of a wave shape.

4. The diaphragm pressure gauge as claimed in claim 1, wherein said pressure measuring unit has a rupture disc which is disposed in said cylindrical chamber and between said first and second diaphragms to protect said first diaphragm from excessive deformation, said connecting rod having a second rod end which extends through said rupture disc.

5. The diaphragm pressure gauge as claimed in claim 1, wherein said pressure measuring unit has an annular spacer disc which is disposed in said cylindrical chamber and between said first and second diaphragms and through which said connecting rod extends, and a seal ring which is disposed to seal between said connecting rod and said spacer disc such that said second subchamber has a differential pressure region defined by said first diaphragm and said spacer disc, said base having a first channel in spatial communication with said first subchamber for entry of the fluid, said spacer disc having a second channel in spatial communication with said differential pressure region for introduction of another fluid.

6. The diaphragm pressure gauge as claimed in claim 1, wherein said connecting rod has a first rod end fastened to said first diaphragm, and a second rod end extending through said second diaphragm and connected with said pressure detecting assembly such that said second diaphragm is tightly engaged with said connecting rod and said pressure detecting assembly.

7. The diaphragm pressure gauge as claimed in claim 1, wherein said second diaphragm is of a cross shape, a bar shape or a Y-shape.

8. The diaphragm pressure gauge for measuring a pressure of a fluid, comprising:
a cylinder having a base and a cover which are connected to each other at peripheral walls thereof to define a cylindrical chamber;
a pressure measuring unit disposed in said cylinder, and having a first diaphragm and a second diaphragm which is spaced apart from said first diaphragm in a lengthwise direction, said cylindrical chamber having a first subchamber which is defined by said base and said first diaphragm and which is configured for introduction of the fluid, a second subchamber which is defined by said first diaphragm and said second diaphragm, and a third subchamber which is defined by said second diaphragm and said cover, said first diaphragm including a main diaphragm layer which has a first flange wall that is clamped between said peripheral walls of said base and said cover, and a first main diaphragm wall that extends radially and inwardly from said first flange wall to divide said cylindrical chamber into said first and second subchambers, and a reinforcing layer that is attached to said first main diaphragm wall and in said second subchamber, said first diaphragm having a raised portion which projects in the lengthwise direction to be connected to said second diaphragm such that said first diaphragm is deformable to permit axial movement thereof in the lengthwise direction when subject to an internal pressure of the fluid introduced in said first subchamber so as to move said second diaphragm; and
a pressure detecting assembly disposed in said third subchamber to detect the movement of said second diaphragm so as to indicate the pressure of the fluid.

9. The diaphragm pressure gauge as claimed in claim 8, wherein said main diaphragm layer has a central portion which is raised over said reinforcing layer to serve as said raised portion.

10. The diaphragm pressure gauge as claimed in claim 8, wherein said main diaphragm layer and said reinforcing layer respectively have central portions which are raised to serve as said raised portion.
